(19) United States
(12) Patent Application Publication
(10) Pub. No.: US 2025/0318988 A1
(43) Pub. Date: Oct. 16, 2025

(54) SAUNA AND METHOD FOR PERFORMING AN AUTOMATIC INFUSION CEREMONY FOR A SAUNA

(71) Applicant: Klafs GmbH, Schwäbisch Hall (DE)

(72) Inventor: Markus Gäbele, Schwäbisch Hall (DE)

(21) Appl. No.: 19/174,652

(22) Filed: Apr. 9, 2025

(30) Foreign Application Priority Data
Apr. 10, 2024 (EP) 24169480.1

(51) Int. Cl. A61H 33/06; A61H 33/00

(52) U.S. Cl. CPC A61H 33/067; A61H 33/6021; A61H 2033/061; A61H 2201/0169; A61H 2201/0207; A61H 2203/0431

(57) ABSTRACT

A sauna is provided with a sauna cabin, a sauna oven, at least one sauna bench with at least one sitting place, and at least one air blast nozzle on or in a ceiling or on or in a wall of the sauna cabin assigned to the at least one sitting place. A compressed air supply is attached to the air blast nozzle, and the air blast nozzle is configured such that an air blast produced by the air blast nozzle impacts at least a section of the sitting place and a space above the sitting place. A method for performing an automatic infusion ceremony for such a sauna is also provided.

### CROSS REFERENCE

This application claims priority to EP Application Serial No. 24169480.1, filed Apr. 10, 2024, the entirety of which is hereby incorporated by reference.

### FIELD OF THE INVENTION

The present invention relates to a sauna, and to a method for performing an automatic infusion ceremony for a sauna.

### BACKGROUND OF THE INVENTION

In the operation of commercial saunas, one of the biggest cost factors is the provision of a sufficient number of sauna masters to carry out air distribution and infusion ceremonies requested by the users. There are automatic infusion devices in the state of the art, as shown in DE 10 2011 120 925 A1, which automatically distribute infusion liquid over a stone bed of a sauna heater. In addition, there are distributors of humid sauna air that distribute the air via fans or fans, as shown in DE 10 2013 019 244 A1, after an infusion in the sauna cabin.

### BRIEF SUMMARY OF THE DRAWINGS

In the following, example embodiments of a sauna and a method are explained in more detail with reference to drawings.

In the drawings:

FIG. 1 shows a schematic side view of a cut through of an example embodiment of a sauna with a schematic plot of the air blast of an air blast nozzle.

FIG. 2 shows a schematic side view of a cut through of an example embodiment of a sauna with schematic plots of the air blasts of air blast nozzles and of a distribution nozzle.

FIG. 3 shows a flow diagram of an embodiment of a method according to an example embodiment.

FIG. 4 shows an example embodiment of an air blast nozzle with its suspension.

FIG. 5 shows a schematic embodiment of an example casing with two suspended air blast nozzles.

FIG. 6 shows a top view of an example embodiment of a sauna without its ceiling.

### DETAILED DESCRIPTION OF THE DRAWINGS

In an example embodiment, a sauna is provided which improves the air distribution in a commercially used sauna in such a way that infusion ceremonies can be carried out with a similar or even improved sauna experience with reduced personnel costs.

A sauna may be provided with a sauna cabin, a sauna oven, at least one sauna bench with at least one sitting place and at least one air blast nozzle on or in a ceiling or on or in a wall of the sauna cabin assigned to the at least one sitting place. A compressed air supply may be attached to the air blast nozzle, and the air blast nozzle may produce an air blast to impact at least a section of the sitting place and a space above the sitting place.

Targeted air blasts can be directed towards the at least one sitting place of the at least one sauna bench, that deliver a comparable sauna experience to a sauna master. These air blasts can be performed by external control or automatized, such that no sauna master must be present inside the sauna cabin.

A sitting place may be a segment of the respective sauna bench with a sitting area which has dimensions such that an average sized users of the sauna can sit on it. In example embodiments, the sitting area may have at least 0.5 m in width and 0.6 m in depth. The average sized user may be between 1.65 m and 1.80 m tall.

A compressed air supply in an example embodiment comprises a compressed air reservoir that is attached to the at least one air blast nozzle and comprises a control such that a controlled amount of compressed air can be delivered to the at least one air blast nozzle. Further, the compressed air supply comprises a device for resupplying the compressed air reservoir after/or during compressed air is delivered to the at least one air blast nozzle. The sauna may comprise several air blast nozzles attached to the same compressed air supply or are attached to respective compressed air supplies. One compressed air supply may be attached to all air blast nozzles to save installation space and costs.

In an example embodiment, the at least one air blast nozzle may be arranged on or in the ceiling of the sauna cabin to facilitate the installation of the sauna and also to improve the sauna experience.

In an example embodiment, the sauna may comprise an automatic infusion device that distributes liquid on a stone bed of the sauna oven. Complete automatic infusion ceremonies including the generation of humidified air and air manipulation can be performed without a sauna master inside the sauna cabin.

In an example embodiment, a length of the air blast is between 1 to 15 sec, or between 3 to 10 sec. A volume flow during the air blast may be between 2 l/sec to 7 l/sec, or between 3 l/sec to 5 l/sec. Such air blasts deliver an advantageous sauna experience, without endangering the user and without excessive cooling down of the temperature inside the sauna cabin due to the introduced air.

The length of the air blast and the volume flow during the air blast can be set within the respective intervals. Thereby, the sauna experience can be modified according to the user's wishes.

In an example embodiment, the air blast nozzle may have a blast direction with an angle relative to the horizontal between 15° to 75°, or between 20° to 60°. The blast direction may be the normal on a plane formed by opening/s of the air blast nozzle and/or the direction of the central axis of the air cone ejected by the air blast nozzle. By this blast direction, an advantageous distribution of the air blast over the body of a user sitting on the respective sitting place can be achieved.

In an example embodiment, a distance between a front edge of the sitting place facing the air blast nozzle and the air blast nozzle may be at least 1 m, or at least 1.5 m. By this distance, an advantageous heat distribution by the air blast is achieved.

In an example embodiment, a distance between a front edge of the sitting place facing the air blast nozzle and the air blast nozzle maybe between 1 and 3 m, or between 1.5 and 2.5 m. By this distance, an advantageous heat distribution by the air blast is achieved.

In an example embodiment, the air blast nozzle may be a fan-shaped nozzle with at least three openings arranged in a line. The air blast nozzle may be a multi-channel flat fan nozzle. Such air blast nozzles achieve a very targeted air blast. Further, the noise level of the air blast can be kept relatively low, which improves the sauna experience.

In an example embodiment, the compressed air supply may apply a pressure to the air blast nozzle during the air blast between 2 and 8 bar, or between 3 and 5 bar. Such pressures generate advantageous air blasts.

In an example embodiment, the air blast nozzle may have a spray angle in a vertical direction between 5° to 40°, or between 15° to 30°. The blast pattern dimensions at the sitting place are advantageous to the sauna experience of the user sitting at the sitting place.

In an example embodiment, the air blast nozzle may be arranged on or in the ceiling within a projected area of the sauna oven onto the ceiling, or may be arranged within a maximal horizontal distance to the projected area of 1 m, or 0.5 m. Thereby, ascending air from the sauna oven is effectively transported towards the user sitting on the sitting place by the air blast. This improves the sauna experience.

In an example embodiment, the air blast nozzle may be configured such that a torso and upper legs of an average sized user sitting at the sitting place is impacted by the air blast. This way the air manipulation of a sauna master is effectively simulated. The air blast nozzle may be configured such that a head of the average sized user sitting at the sitting place is not impacted by the air blast of the air blast nozzle assigned to the sitting place. This increases security for the user.

In an example embodiment, the compressed air supply may comprise a heating unit to preheat the compressed air before the compressed air supply supplies the compressed air to the at least one air blast nozzle. Thereby the gas temperature of the air blast can be adjusted, which is for example important due to the Joule-Thomson effect.

In an example embodiment, the sauna may comprise at least two sauna benches of the at least one sauna bench. Each of the at least two sauna benches may comprise at least two sitting places. Each sitting place may be assigned one of the at least one air blast nozzle. This allows several users to experience the automatic infusion ceremony in one sitting. The sitting places may be arranged on the sauna benches such that a complete surface of the respective sauna bench is covered by sitting places. An air blast nozzle may be assigned to each sitting place. Accordingly, every possible user of the sauna can experience the automatic infusion ceremony.

In an example embodiment, the sauna may comprise a lower sauna bench and a upper sauna bench arranged step-shaped to each other. The angle relative to the horizontal of the blast direction of the air blast nozzles assigned to sitting places of the upper sauna bench may be smaller than the angle relative to the horizontal of the blast direction of the air blast nozzles assigned to sitting places of the lower sauna bench. The air blast nozzles may be arranged such that the blast directions of the respective air blast nozzles do not intersect. Thereby, the air blast of each air blast nozzle is not heavily obstructed, in case air blasts are executed simultaneously.

In an example embodiment, the air blast nozzle may be suspended in a casing fixed to or in the ceiling. The casing may comprise an opening onto which the air blast nozzle is directed to such that the air blast of the air blast nozzle leaves the casing through the opening unobstructed by the casing. This increases safety, as the air blast nozzle is not directly accessible for example by a user. Additionally, this dampens the sound level in the sauna cabin, as the sound propagation of the air blast nozzle can be dampened by the casing. Passive noise cancelling material may be arranged inside the casing. This lessens the sound propagation of the air blast nozzle into the sauna cabin.

In an example embodiment, two air blast nozzles assigned to two sitting places may be suspended in the casing. The casing may either comprise one opening onto which the air blast nozzles are directed to, such that the air blast of the air blast nozzles leaves the casing through the opening unobstructed by the casing, or two openings, such that respectively one of the two air blast nozzles are directed such that the air blast of the air blast nozzle leaves the casing through one of the two openings unobstructed by the casing. This allows components to be reduced. The two sitting places may be arranged on two sauna benches and lie in a same horizontal direction in regard to the casing. This facilitates the suspension inside the casing, as only the angle relative to the horizontal has to be different for the two air blast nozzles.

In an example embodiment, the air blast nozzle may be at least 5° pivotable in the vertical direction. This allows a fine adjustment of the blast direction of the air blast nozzle. Further, the sauna may comprise several air blast nozzles assigned to several sitting places, and the respective air blasts may be directed such that different user heights for the respective sitting places are accustomed for.

In an example embodiment, the sauna may comprise a speaker. The speaker may be configured to play sounds that are masking or integrating noise generated by the air blast of the air blast nozzle. This improves the sauna experience. Also, the speaker may play safety instructions to indicate that an air blast is imminent and/or give allergy information concerning the liquid used by the automatic infusion device. Thereby, the security of the sauna can be improved.

In an example embodiment, the sauna may comprise an active noise-cancelling device that actively dampens a sound produced by the air blast nozzle, when producing the air blast. This can improve the noise level during air blasts, which on the other hand improves the sauna experience.

In an example embodiment, a light may be arranged at or in the at least one air blast nozzle. The light may be directed towards the sitting place assigned to the at least one air blast nozzle. The light can be used as a signal to the user, which increases the security. The light may be switched before and during the air blast. Thereby, an imminent air blast is indicated to the user.

In an example embodiment, the sauna may comprise a first sensor system to recognize whether a user is occupying the sitting place. The air blast nozzle may only generate an air blast when a user is occupying its assigned sitting place. The first sensor system may include a weight sensor or a distance sensor. This avoids unnecessary air blasts. The sauna may comprise the first sensor system for every sitting place with an assigned air blast nozzle.

In an example embodiment, the sauna may comprise a second sensor system to recognize whether a safety space starting from the air blast nozzle and extending in the blast direction is unoccupied. The second sensor system may include a weight sensor, for example in the floor beneath and/or around the air blast nozzle, a distance sensor or an image recognition sensor. This increases safety. The sauna may comprise the second sensor system for every air blast nozzle.

In an example embodiment, the sauna may comprise at least one distribution nozzle arranged on or in a ceiling of the sauna cabin and in view of the at least one sitting place behind the at least one air blast nozzle assigned to the at least one sitting place. The at least one distribution nozzle may be attached to the compressed air supply and may have a blow direction with an angle relative to the horizontal between 3° to 30°, or between 5° to 20°. Thereby, the at least one distribution nozzle can distribute hot air of a ceiling air layer inside the sauna cabin and the air blast of the at least one air blast nozzle carries the better distributed air with it. This improves the sauna experience. A central axis of the sauna oven may be arranged between the at least one distribution nozzle and the at least one air blast nozzle. Thereby, ascending hot air heated by the sauna oven is distributed by the at least one distribution nozzle.

In an example embodiment, the sauna oven may be arranged in a corner of the sauna cabin. The at least one distribution nozzle may be arranged in the corner closer to the corner than the central axis of the sauna oven.

In an example embodiment, the at least one sauna bench may have a u-shape. The sauna oven may be arranged within the u-shape.

An example method for performing an automatic infusion ceremony for a sauna may comprise steps including: pouring on infusion liquid onto the stone bed of the sauna oven by the automatic infusion device; and blasting ascending humidified air above the sauna oven towards the at least one sitting place by the at least one air blast nozzle on or in a ceiling of the sauna cabin assigned to the at least one sitting place.

With such a method, the personnel requirements for commercially used saunas can be significantly reduced and users can nevertheless be offered equivalent infusion ceremonies. The fact that no sauna master enters the sauna can also increase the frequency of infusion ceremonies.

In an example embodiment, the method comprises a step between the two steps above in which the ascending humidified air is distributed above the sauna oven in a ceiling air layer by the at least one distribution nozzle. Thereby, the air quality of the air blast/s by the at least one air blast nozzle can be improved and hence the sauna experience is improved.

In an example embodiment consecutive blasting of ascending humidified air towards several sitting places by the several air blast nozzles assigned to the several sitting places may occur. By consecutively generating the air blasts, the sauna experience better simulates a traditional infusion ceremony by a sauna master. Further, the dimensioning of the compressed air supply can be reduced.

In the following Figures, identical parts are identified by the same reference signs. Insofar as a Figure contains reference signs which are not explicitly referred to in the associated Figure description, reference is made to preceding or subsequent Figure descriptions.

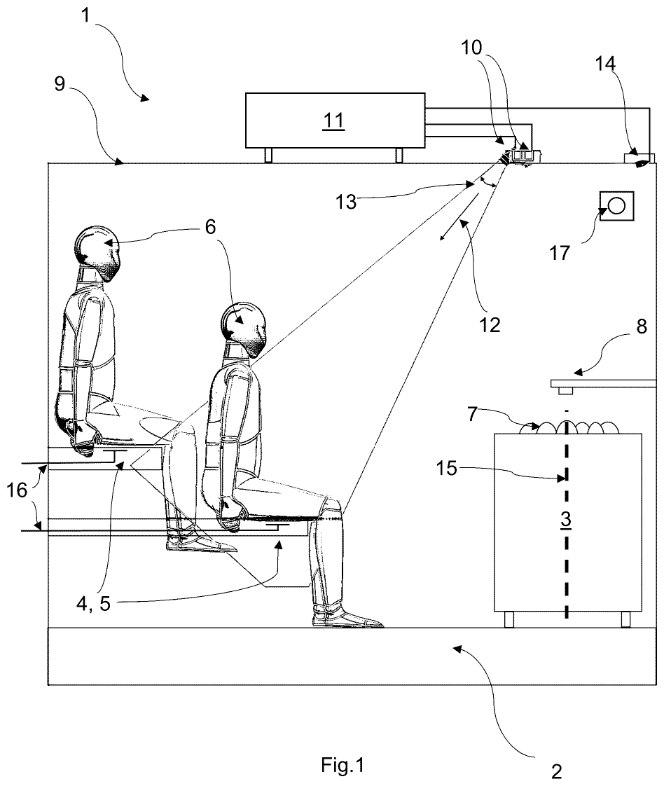

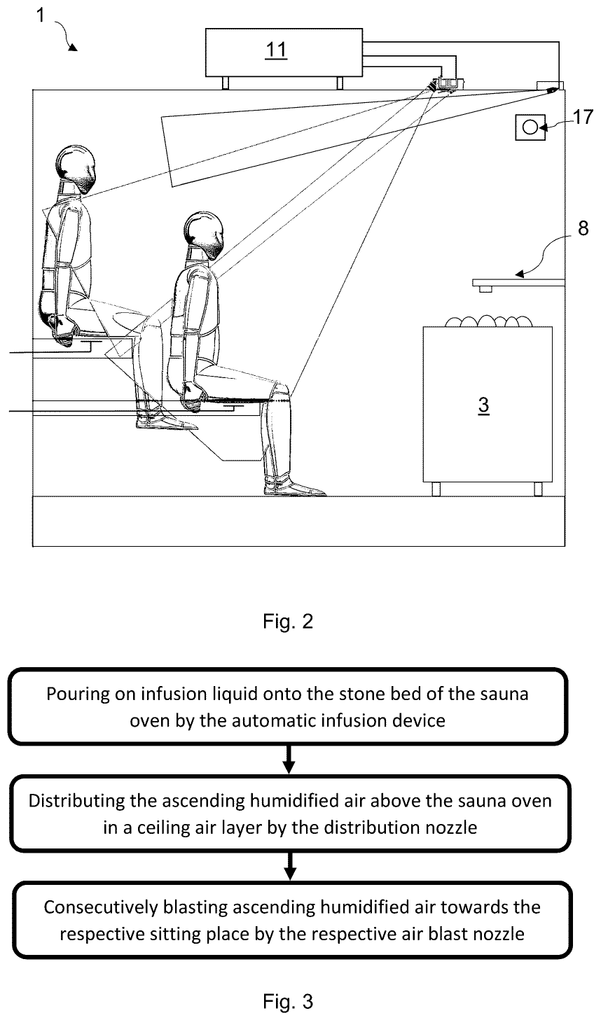

FIGS. 1 and 2 show an embodiment of a sauna 1 according to the invention. The sauna 1 comprises a sauna cabin 2, in which a sauna oven 3 and two sauna benches 4—one above the other and in a step-form arrangement—are arranged. The two sauna benches 4 comprise sitting places 5, which are a segment of the respective sauna bench 4 with a sitting area which has such dimensions that an average sized users 6 of the sauna 1 can sit on it. In both sitting places 5 a first sensor 16 is arranged, which detects whether a user 6 is occupying the sitting place 5. FIGS. 1 and 2 show two exemplary users 6 sitting on a respective sitting place 5 of a respective sauna bench 4.

The sauna oven 3 comprises a stone bed 7 and an automatic infusion device 8 is arranged above the stone bed 7, such that an infusion liquid can be distributed over the stone bed 7 by the automatic infusion device 8.

At the ceiling 9 two air blast nozzles 10 are arranged, which are connected to a compressed air supply 11 that is arranged on top of the sauna cabin 2. The air blast nozzles 10 are configured as fan-shaped nozzles and each is assigned to one of the respective sitting places 5. When the compressed air supply 11 supplies compressed air, for example at 4 bar, to the respective air blast nozzle 10, the air blast nozzles 10 are configured such that a torso and upper legs of the average sized user 6 sitting at the respective sitting place 5 to which the respective air blast nozzle 10 is assigned to be impacted by an air blast exiting the respective air blast nozzle 10. For this, the blast direction 12 of the respective air blast nozzle 10 is directed towards the assigned sitting place 5, the air blast nozzle 10 has a spray angle 13 in a vertical direction of 25° and a distance between a front edge of the respective sitting place 5 facing the respective air blast nozzle 10 and the respective air blast nozzle 10 is above 1.5 m.

Further, the air blast nozzles 10 are arranged in the ceiling 9 within a projected area of the sauna oven 3 onto the ceiling 9. With this, ascending hot air of the sauna oven is carried on by the air blasts towards the respective user 6. Such an air blast simulates the air manipulation by a sauna master during an infusion ceremony.

Further, the sauna 1 shown in FIGS. 1 and 2 comprises a distribution nozzle 14, which is arranged on the ceiling 9 of the sauna cabin 2 and in view of the sitting place 5 behind the air blast nozzles 10, wherein a central axis 15 of the sauna oven 3 is arranged between the distribution nozzle 12 and the air blast nozzles 10. The distribution nozzle 14 is also attached to the compressed air supply 11 and is configured as a fan-shaped nozzle. The blow direction of the distribution nozzle 14 has a smaller angle to the horizontal than the blast direction 12 of the air blast nozzles 10, such that the blast of the distribution nozzle 14 is directed into a ceiling air layer of the sauna cabin 2. Due to the arrangement of the distribution nozzle 14, ascending hot air of the sauna oven 3 is distributed in the ceiling air layer and especially is pushed in front of the air blast nozzles 10.

Further, the sauna 1 shown in FIGS. 1 and 2 comprises an active noise-cancelling device 17 that is configured to actively dampen a sound produced by the air blast nozzles 10 or distribution nozzle 14.

With such a sauna 1, an embodiment of the method according to the invention as shown in FIG. 3 can be carried out, wherein the sauna 1 has a corresponding control system for this purpose, which automatically carries out the following steps. First, the infusion is performed by means of the automatic infusion device 8, wherein an infusion liquid is poured onto the stone bed 7 of the sauna oven 3 by the automatic infusion device 8. Then, the ascending humidified air above the sauna oven 3 is distributed in the ceiling air layer by one or several blasts of the distribution nozzle 14. Lastly, the air blast nozzles 10, one after the other, each perform at least one blast towards its assigned sitting place 5, in case the first sensor 16 detects that a user 6 is occupying the sitting place 5. During the blasts of the distribution nozzle 14 and the air blasts of the air blast nozzles 10, the active noise-cancelling device 17 may dampen the produced sound.

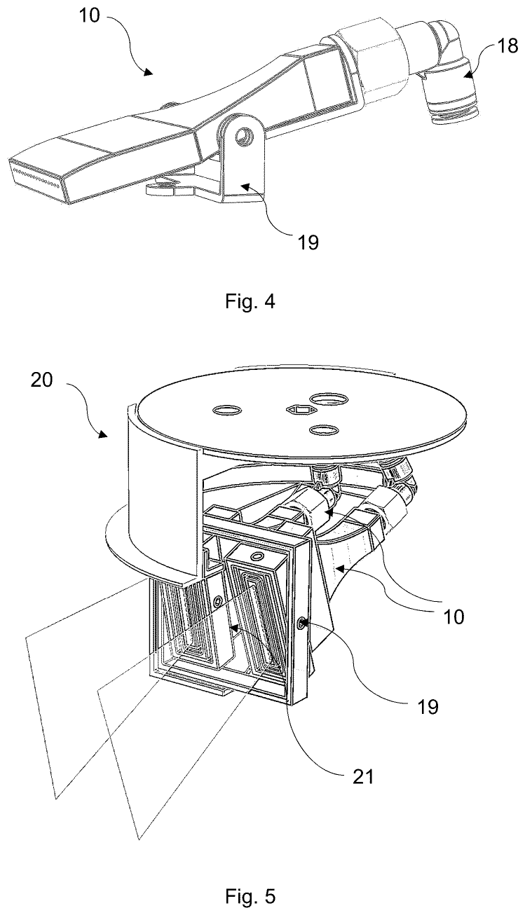

FIG. 4 shows an air blast nozzle 10 that is part of a sauna 1 according to an embodiment of the invention. The air blast nozzle 10 is a fan-shaped nozzle, which comprises a multitude of openings that are arranged in a line. This air blast nozzle 10 comprises a connector 18 by which the air blast nozzle 10 can be connected to the compressed air supply 11. Further, the air blast nozzle 10 is arranged inside a suspension 19, which allows a change of the blast direction 12 by several degrees. The suspension 19 can be fixated inside a casing 20, which is fixed to the ceiling 9 and comprises an opening 21, through which an air blast generated by the air blast nozzle 10 exits the casing 20 unobstructed.

FIG. 5 shows a casing 20 in which two air blast nozzles 10 are suspended that are part of a sauna 1 according to another embodiment of the invention. The casing 20 can fixed partly into the ceiling 9 of the sauna 1. The two air blast nozzles 10 are configured as fan-shaped nozzles and are directed towards an opening 21 of the casing, wherein the blast direction 12 of the two air blast nozzles 10 are different from each other, such that the air blast nozzles 10 are directed to two different sitting places 5, for example on two sauna benches 4 that are arranged step-shaped to each other. The suspension 19 of the two air blast nozzles is again configured such that a change of the blast direction 12 by several degrees is allowed.

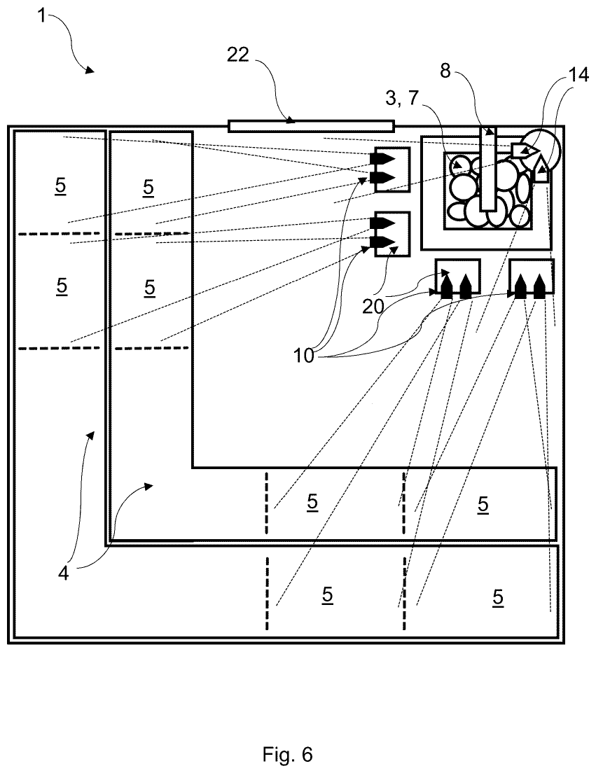

FIG. 6 shows another embodiment of a sauna 1 according to the invention. The sauna 1 comprises a sauna oven 3 and an automatic infusion device that are arranged in a corner of the sauna cabin 2. Two L-shaped sauna benches 4 are arranged opposite of the corner and step-shaped to each other. Eight air blast nozzles 10 in casings 20 are arranged on the ceiling 9, wherein their blast directions 12 are directed to eight sitting places 5, four on each sauna bench 4. Further, two distribution nozzle 14, also in a casing, are also arranged on the ceiling 9, wherein the distribution nozzle 14 are arranged in the corner closer to the corner than the central axis 13 of the sauna oven 3. The respective air blast nozzles 10 are arranged further away from the corner than the central axis 13 of the sauna oven 3.

### LIST OF REFERENCE SIGNS

1 sauna
2 sauna cabin
3 sauna oven
4 sauna bench
5 sitting place
6 average sized user
7 stone bed
8 automatic infusion device
9 ceiling
10 air blast nozzle
11 compressed air supply
12 blast direction
13 spray angle
14 distribution nozzle
15 central axis
16 first sensor
17 active noise-cancelling device
18 connector
19 suspension
20 casing
21 opening
22 door

1. A sauna comprising:
a sauna cabin having at least one wall and a ceiling;
a sauna oven;
at least one sauna bench with at least one sitting place;
a compressed air supply; and
at least one air blast nozzle attached to the compressed air supple, the at least one air blast nozzle being positioned on or in the ceiling or on or in the at least one wall of the sauna cabin,
wherein the at least one air blast nozzle is assigned to the at least one sitting place,
wherein the air blast nozzle produces an air blast that impacts at least a section of the sitting place and a space above the sitting place.

2. The sauna according to claim 1, further comprising an automatic infusion device that distributes liquid on a stone bed of the sauna oven.

3. The sauna according to claim 1, wherein the air blast nozzle has a blast direction with an angle relative to the horizontal between 15° to 75°.

4. The sauna according to claim 1, wherein a distance between a front edge of the sitting place facing the air blast nozzle and the air blast nozzle is at least 1 m.

5. The sauna according to claim 1, wherein the air blast nozzle is fan-shaped nozzle with at least three openings arranged in a line.

6. The sauna according to claim 1, wherein the compressed air supply applies a pressure to the air blast nozzle during the air blast between 2 and 8 bar.

7. The sauna according to claim 1, wherein the air blast nozzle has a spray angle in a vertical direction between 5° to 40°.

8. The sauna according to claim 1, wherein the air blast nozzle is arranged on or in the ceiling within a projected area of the sauna oven onto the ceiling or is arranged within a maximal horizontal distance to the projected area of 1 m.

9. The sauna according to claim 1, wherein a torso and upper legs of an average sized user sitting at the sitting place is impacted by the air blast, wherein a head of the average sized user sitting at the sitting place is not impacted by the air blast of the air blast nozzle assigned to the sitting place.

10. The sauna according to claim 1, wherein the compressed air supply comprises a heating unit to preheat the compressed air before the compressed air supply supplies the compressed air to the at least one air blast nozzle.

11. The sauna according to claim 1, wherein the air blast nozzle is at least 5° pivotable in the vertical direction.

12. The sauna according to claim 1, further comprising at least two sauna benches of the at least one sauna bench, wherein each of the at least two sauna benches comprise at least two sitting places and wherein each sitting place is assigned one of the at least one air blast nozzle.

13. The sauna according to claim 1, further comprising at least one distribution nozzle arranged on or in a ceiling of the sauna cabin and in view of the at least one sitting place behind the at least one air blast nozzle assigned to the at least one sitting place, wherein the at least one distribution nozzle is attached to the compressed air supply and has a blow direction with an angle relative to the horizontal between 3° to 30°.

14. A method for performing an automatic infusion ceremony for a sauna according to claim 2, the method comprising:
pouring infusion liquid onto a stone bed of the sauna oven by the automatic infusion device,
blasting ascending humidified air above the sauna oven towards the at least one sitting place by the at least one air blast nozzle on or in a ceiling of the sauna cabin assigned to the at least one sitting place.

15. The method according to claim 14, the method further comprising the step of: after the pouring step but before the blasting step, distributing the ascending humidified air above the sauna oven in a ceiling air layer by the at least one distribution nozzle.

16. The sauna according to claim 3, wherein the air blast nozzle has a blast direction with an angle relative to the horizontal between 20° to 60°.

17. The sauna according to claim 5, wherein the air blast nozzle is a multi-channel flat fan nozzle.

18. The sauna according to one claim 6, wherein the compressed air supply applies a pressure to the air blast nozzle during the air blast between 3 and 5 bar.

19. The sauna according to claim 7, wherein the air blast nozzle has a spray angle in a vertical direction between 15° to 30°.

20. The sauna according to claim 13, wherein the at least one distribution nozzle has a blow direction with an angle relative to the horizontal between 5° to 20°.
